(19) United States
(12) Patent Application Publication
(10) Pub. No.: US 2025/0347968 A1
(43) Pub. Date: Nov. 13, 2025

(54) TRANSMISSIVE ELECTROPHORETIC DISPLAY DEVICE AND MANUFACTURING METHOD THEREOF

(71) Applicant: E Ink Holdings Inc., Hsinchu (TW)

(72) Inventors: Wen Ya Chao, Hsinchu (TW); Wen-Yu Kuo, Hsinchu (TW); Liang-Yu Lin, Hsinchu (TW); Kuang-Heng Liang, Hsinchu (TW)

(73) Assignee: E Ink Holdings Inc., Hsinchu (TW)

(21) Appl. No.: 19/097,787

(22) Filed: Apr. 1, 2025

(30) Foreign Application Priority Data
May 8, 2024 (TW) 113116982

(51) Int. Cl. G02F 1/1676; G02F 1/1362; G02F 1/167; G02F 1/16755

(52) U.S. Cl. CPC G02F 1/1676; G02F 1/1362; G02F 1/167; G02F 1/16755

(57) ABSTRACT

A transmissive electrophoretic display device and a manufacturing method thereof. The transmissive electrophoretic display device has multiple pixel regions. Each pixel region has a light-transmitting region and a non-light-transmitting region. The transmissive electrophoretic display device includes an element array substrate, a partition layer, an electrophoretic layer, and a light-transmitting conductive substrate. The element array substrate includes multiple first control electrodes, respectively disposed in the light-transmitting regions, and multiple second control electrodes, respectively disposed in the non-light-transmitting regions. The partition layer is disposed on the element array substrate and has multiple openings. In a cross-sectional view, two adjacent partition walls in the partition layer are respectively disposed on opposite sides of a corresponding first control electrode. The electrophoretic layer is disposed in the openings. The light-transmitting conductive substrate covers the partition layer and the electrophoretic layer.

### CROSS-REFERENCE TO RELATED APPLICATION

This application claims the priority benefit of Taiwan application serial no. 113116982, filed on May 8, 2024. The entirety of the above-mentioned patent application is hereby incorporated by reference herein and made a part of this specification.

### BACKGROUND

### Technical Field

The disclosure relates to an electrophoretic display device and a manufacturing method thereof, and in particular to a transmissive electrophoretic display device and a manufacturing method thereof.

### Description of Related Art

In conventional electrophoretic display devices, the front plane laminate with the electrophoretic layer is attached to the element array substrate through the adhesive layer. As the pixel electrodes in the element array substrate are usually not aligned with the microcapsules or microcups in the electrophoretic layer, and the adhesive layer has a darker color, conventional electrophoretic display devices are usually not light-transmitting.

### SUMMARY

The disclosure provides a transmissive electrophoretic display device and a manufacturing method thereof. The transmissive electrophoretic display device is light-transmitting.

In an embodiment of the disclosure, the transmissive electrophoretic display device has multiple pixel regions. Each of the pixel regions has a light-transmitting region and a non-light-transmitting region. The transmissive electrophoretic display device includes an element array substrate, a partition layer, an electrophoretic layer, and a light-transmitting conductive substrate. The element array substrate includes multiple first control electrodes and multiple second control electrodes. The first control electrodes are respectively disposed in the light-transmitting regions in the pixel regions. The second control electrodes are respectively disposed in the non-light-transmitting regions in the pixel regions. The partition layer is disposed on the element array substrate and has multiple openings exposing the light-transmitting regions. In a cross-sectional view, the partition layer includes multiple partition walls. Two adjacent partition walls of the partition walls are respectively disposed on opposite sides of a corresponding first control electrode of the first control electrodes. The electrophoretic layer is disposed in the openings. The light-transmitting conductive substrate covers the partition layer and the electrophoretic layer.

In another embodiment of the disclosure, the transmissive electrophoretic display device has multiple pixel regions. Each of the pixel regions has a light-transmitting region and a non-light-transmitting region. A manufacturing method of a transmissive electrophoretic display device includes the following steps. An element array substrate is provided. The element array substrate includes multiple first control electrodes and multiple second control electrodes. The first control electrodes are respectively disposed in the light-transmitting regions in the pixel regions, and the second control electrodes are respectively disposed in the non-light-transmitting regions in the pixel regions. A partition layer is formed on the element array substrate through a photolithography process. The partition layer has multiple openings respectively exposing the light-transmitting regions. An electrophoretic layer is filled in the openings. The partition layer and the electrophoretic layer are covered by a light-transmitting conductive substrate.

To make the aforementioned features and advantages of the disclosure more apparent and comprehensible, several embodiments accompanied with drawings are described in detail as follows.

### BRIEF DESCRIPTION OF THE DRAWINGS

FIGS. 1, 2, and 3 are three top-view schematic diagrams of a same region of a transmissive electrophoretic display device according to some embodiments of the disclosure, respectively showing different elements in the region to clearly display relative disposition relationships between different elements.

FIGS. 4, 5, 6, 7, 8, 9, 10, 11, and 12 are partial cross-sectional schematic diagrams of various transmissive electrophoretic display devices according to some embodiments of the disclosure. FIGS. 4 to 12 are, for example, cross-sectional views corresponding to Cutline I-I′ in FIGS. 1 to 3.

### DESCRIPTION OF THE EMBODIMENTS

In the following embodiments, terms used to indicate directions, such as “up,” “down,” “front,” “back,” “left,” and “right,” merely refer to directions in the accompanying drawings. Therefore, the directional terms used are regarded as illustrative rather than restrictive of the disclosure.

In the accompanying drawings, the drawings illustrate the general features of the methods, structures, or materials used in the particular embodiments. However, the drawings shall not be interpreted as defining or limiting the scope or nature covered by the embodiments. For example, the relative size, thickness, and location of film layers, regions, or structures may be reduced or enlarged for clarity.

The same or similar reference numerals are adopted for the same or similar elements in the accompanying drawings, and repeated description thereof is omitted. In addition, features in different exemplary embodiments may be combined with each other without conflict, and simple equivalent changes and modifications made in accordance with the specification or claims still fall within the scope of the disclosure.

Terms such as “first” and “second” in the specification or claims are used only to name

different elements or to distinguish different embodiments or scopes and should not be construed as the upper limit or lower limit of the number of any elements and should not be construed to limit a manufacturing order or an arrangement order of the elements. In addition, one element/film layer disposed on (or above) another element/film layer may cover a situation that the element/film layer is directly disposed on (or above) the other element/film layer, and the two elements/film layers directly contact each other; or a situation that the element/film layer is indirectly disposed on (or above) the other element/film layer, and one or more additional element/film layers exist between the two elements/film layers.

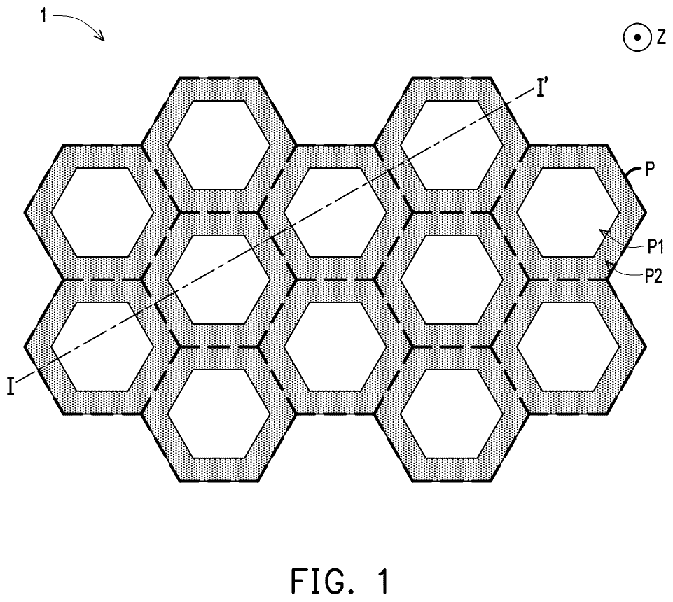

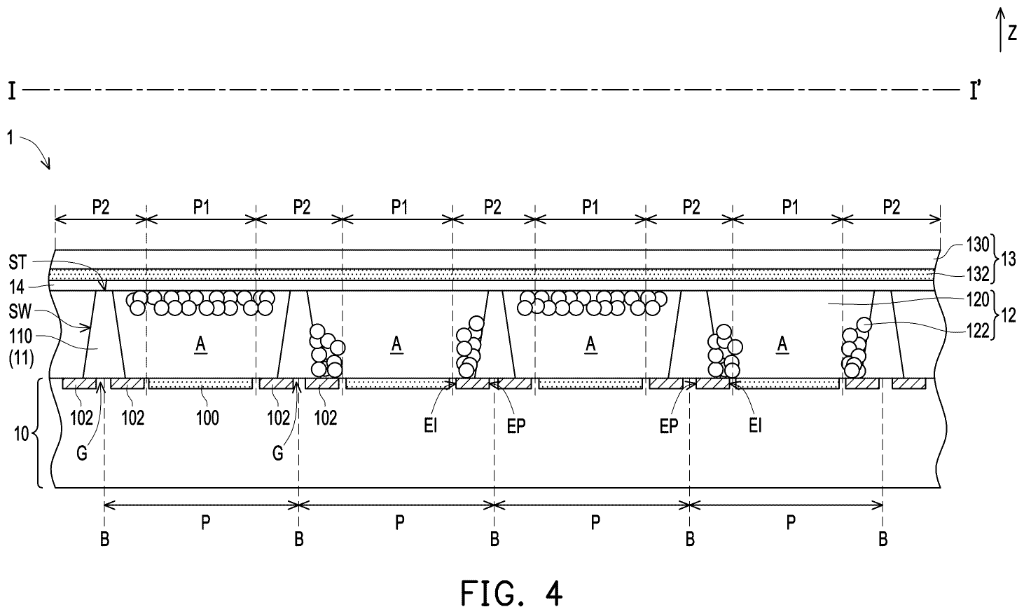

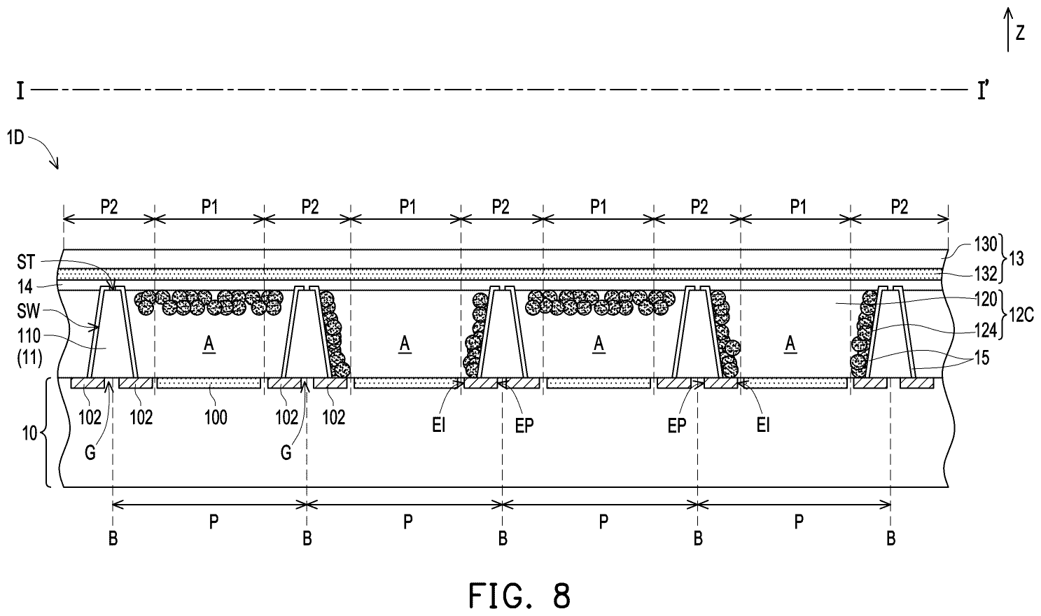

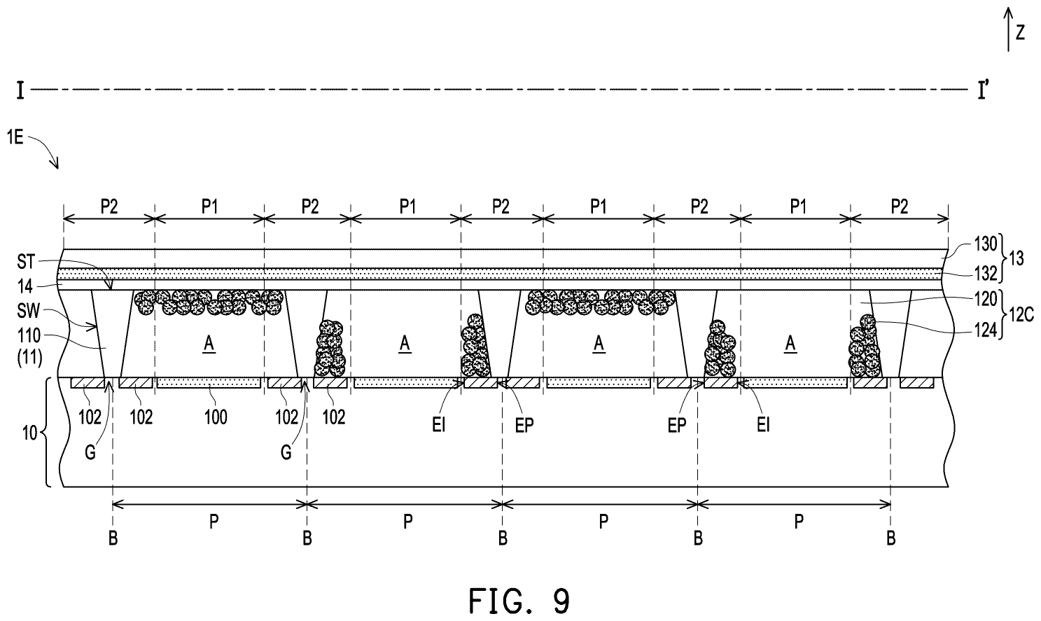

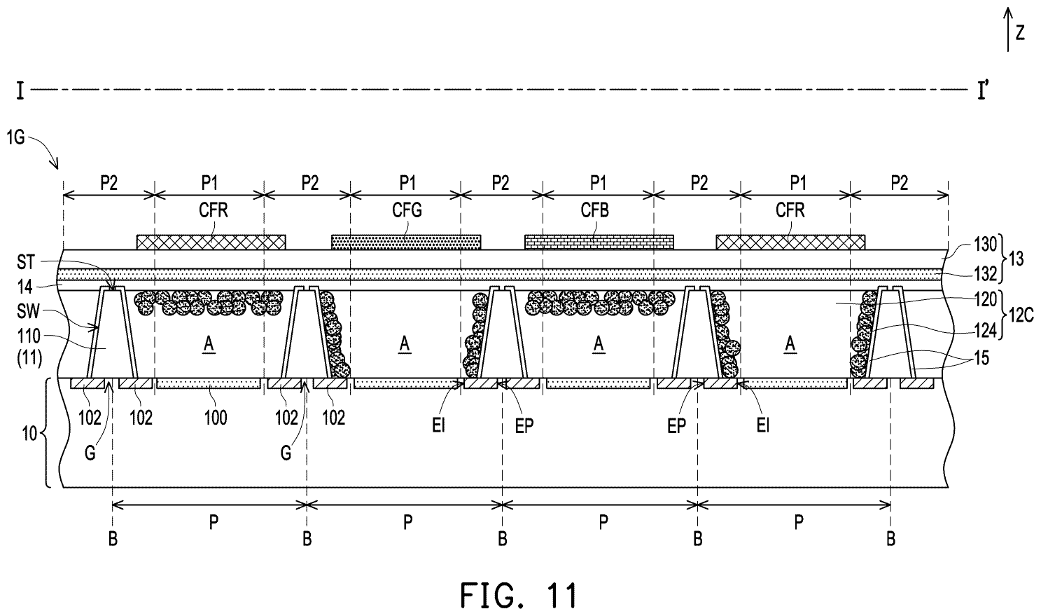

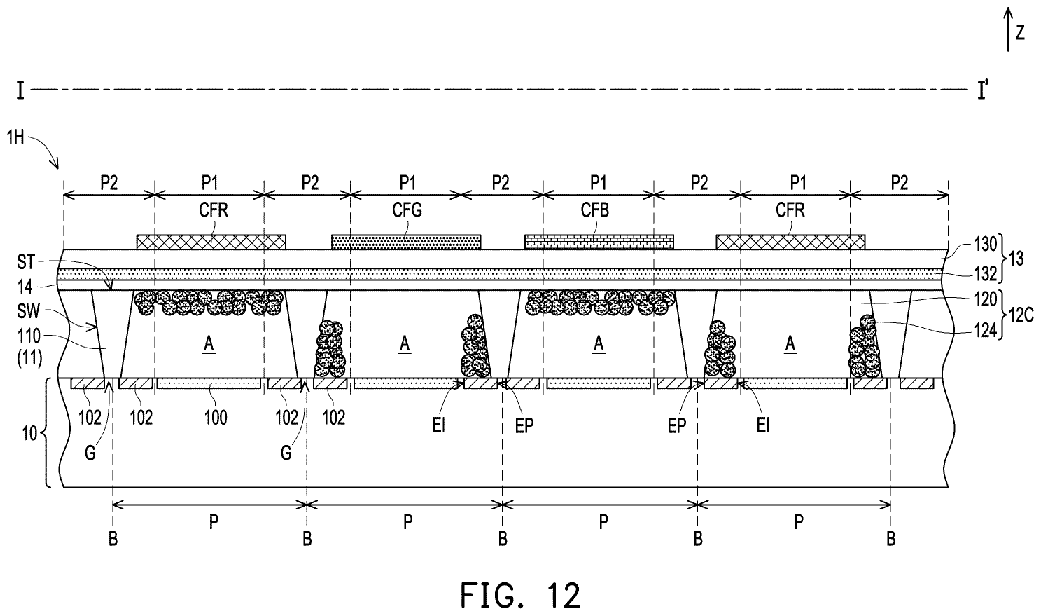

FIGS. 1, 2, and 3 are three top-view schematic diagrams of a same region of a transmissive electrophoretic display device according to some embodiments of the disclosure, respectively showing different elements in the region to clearly display relative disposition relationships between different elements. FIGS. 4, 5, 6, 7, 8, 9, 10, 11, and 12 are partial cross-sectional schematic diagrams of various transmissive electrophoretic display devices according to some embodiments of the disclosure. FIGS. 4 to 12 are, for example, cross-sectional views corresponding to Cutline I-I′ in FIGS. 1 to 3.

Referring to FIGS. 1 to 4, a transmissive electrophoretic display device 1 has multiple pixel regions P. Each of the pixel regions P has a light-transmitting region P1 and a non-light-transmitting region P2. The transmissive electrophoretic display device 1 includes an element array substrate 10, a partition layer 11, an electrophoretic layer 12, and a light-transmitting conductive substrate 13. The element array substrate 10 includes multiple first control electrodes 100 and multiple second control electrodes 102. The first control electrodes 100 are respectively disposed in the light-transmitting regions P1 in the pixel regions P. The second control electrodes 102 are respectively disposed in the non-light-transmitting regions P2 in the pixel regions P. The partition layer 11 is disposed on the element array substrate 10 and has multiple openings A exposing the light-transmitting regions P1. In a cross-sectional view, as shown in FIG. 4, the partition layer 11 includes multiple partition walls 110. Two adjacent partition walls 110 of the partition walls 110 are respectively disposed on opposite sides of a corresponding first control electrode 100 of the first control electrodes 100. The electrophoretic layer 12 is disposed in the openings A. The light-transmitting conductive substrate 13 covers the partition layer 11 and the electrophoretic layer 12.

Specifically, please refer to FIG. 1 first. FIG. 1 schematically illustrates twelve pixel regions P of the transmissive electrophoretic display device 1, but the number of pixel regions P is not limited thereto. For convenience in identification, each pixel region P is labeled with a bold dashed line in FIG. 1. In some embodiments, the pixel regions P may be arranged in arrays so as to realize planar display. In some embodiments, as shown in FIG. 1, a shape of each pixel region P may be hexagonal in a top view, and the pixel regions P may be alternately arranged to improve an aperture ratio and/or resolution, but the disclosure is not limited thereto.

Each pixel region P has a light-transmitting region P1 and a non-light-transmitting region P2, wherein the light-transmitting region P1 allows for light transmission, and the non-light-transmitting region P2 is for disposing non-light-transmitting elements or film layers (e.g., switching elements, metal lines, storage capacitors, and/or multiple partition walls). In some embodiments, although not shown, the non-light-transmitting elements or film layers may be shielded by disposing a light-shielding layer (e.g., a black matrix, dark ink, or other light-shielding materials) in the non-light-transmitting region P2. For convenience in identification, in FIG. 1, the light-transmitting region P1 is shown with a white background while the non-light-transmitting region P2 is shown with a dotted mesh background.

In some embodiments, the non-light-transmitting region P2 in each pixel region P may be connected to the light-transmitting region Pl and located on at least one side of the light-transmitting region P1. In some embodiments, as shown in FIG. 1, the non-light-transmitting region P2 in each pixel region P surrounds the light-transmitting region P1. In some embodiments, as shown in FIG. 1, a shape of the light-transmitting region P1 may be hexagonal in a top view, and a shape of the non-light-transmitting region P2 may be a hexagonal ring in a top view, but the disclosure is not limited thereto. In some embodiments, as shown in FIG. 1, the non-light-transmitting regions P2 in the pixel regions P may be connected to each other, and two adjacent light-transmitting regions P1 may be separated by two connected non-light-transmitting regions P2.

In a top view as shown in FIG. 1, if an area of the light-transmitting region P1 is A1 and an area of the non-light-transmitting region P2 is A2, an area of the pixel region P is (A1+A2). The aperture ratio of the pixel region P may be defined as the area of the light-transmitting region P1 divided by the area of the pixel region P and then multiplied by 100%, that is, [A1/(A1+A2)]*100%. By controlling the aperture ratio of the pixel regions P, the entire transmissive electrophoretic display device 1 is light-transmitting. The transmissive electrophoretic display device 1 may be more widely applied. For example, the transmissive electrophoretic display device may be applied to windows or doors of display windows, transportation vehicles (e.g., sightseeing buses, ships, vehicle bodies), or commercial buildings for intelligent operation, introduction, instruction, or guidance purposes. In some embodiments, the aperture ratio of the pixel regions P may be 60% to 80%, that is, 60%≤[A1/(A1+A2)]*100%≤80%, but is not limited thereto.

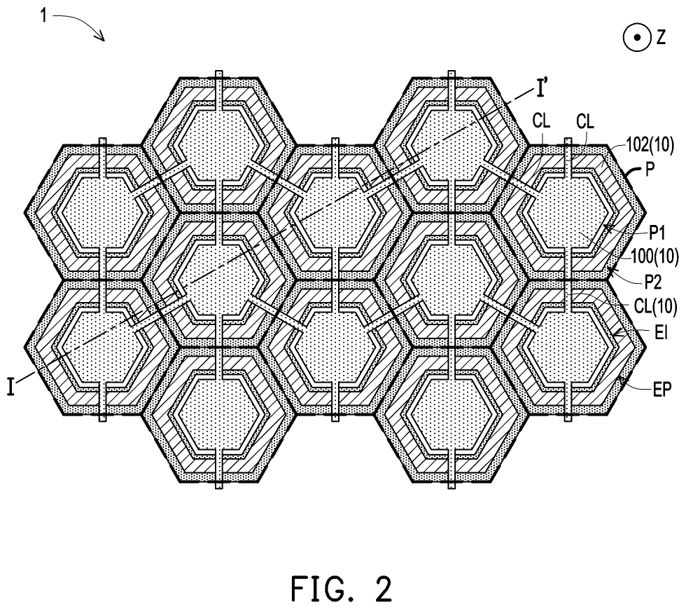

Referring to FIGS. 2 and 4, the element array substrate 10 is, for example, an active element array substrate. At least one first control electrode 100 is disposed in each light-transmitting region P1, and at least one second control electrode 102 is disposed in each non-light-transmitting region P2. The first control electrodes 100 disposed in the light-transmitting regions P1 may be made of a light-transmitting conductive material to improve the light transmittance of the light-transmitting regions P1. On the other hand, the second control electrodes 102 disposed in the non-light-transmitting regions P2 may be made of a light-transmitting conductive material or a non-light-transmitting conductive material. The light-transmitting conductive material may include metal oxides, graphene, other suitable transparent conductive materials, or combinations thereof. Metal oxides may include indium tin oxide, indium zinc oxide, aluminum tin oxide, aluminum zinc oxide, indium germanium zinc oxide, or other metal oxides. Non-light-transmitting conductive materials may include metals, alloys, or combinations thereof. If the first control electrodes 100 and the second control electrodes 102 are made of the same conductive material (e.g., a light-transmitting conductive material), the first control electrodes 100 and the second control electrodes 102 may be formed through the same patterning process to simplify the manufacturing steps. If the second control electrodes 102 are made of a non-light-transmitting conductive material such as metal, alloy, or a combination thereof, the second control electrodes 102 may have lower impedance and/or better electrical conductivity.

In some embodiments, in a top view as shown in FIG. 2, an area of the first control electrode 100 may be slightly smaller than the area of the light-transmitting region P1, but is not limited thereto. In other embodiments, the area of the first control electrode 100 may be equal to the area of the light-transmitting region P1. Alternatively, the area of the first control electrode 100 may be slightly greater than the area of the light-transmitting region P1, enabling a portion of the first control electrode 100 to extend into the non-light-transmitting region P2. In some embodiments, in a top view as shown in FIG. 2, the second control electrodes 102 may respectively surround the first control electrodes 100. For example, a shape of the first control electrode 100 may be hexagonal in a top view, and a shape of the second control electrode 102 may be a hexagonal ring in a top view, but the disclosure is not limited thereto.

In some embodiments, the first control electrodes 100 may be electrically connected to each other while the second control electrodes 102 may be electrically independent of each other. For example, in FIG. 2, the element array substrate 10 may further include multiple connecting lines CL. The first control electrodes 100 may be electrically connected to each other through the connecting lines CL. For example, in FIG. 2, each connecting line CL may cross two adjacent second control electrodes 102 so that two adjacent first control electrodes 100 are electrically connected. In this structure, the connecting lines CL and the second control electrodes 102 are formed sequentially, and the connecting lines CL are electrically insulated from the second control electrodes 102 through at least one insulating layer (not shown).

For example, the connecting lines CL may be formed using the same conductive material (e.g., a light-transmitting conductive material) and the same patterning process as the first control electrodes 100. The second control electrodes 102 are formed before or after the formation of the connecting lines CL and the first control electrodes 100. Alternately, the first control electrodes 100 and the second control electrodes 102 may be made of the same conductive material (e.g., a light-transmitting conductive material) through the same patterning process. The connecting lines CL are formed before or after the formation of the first control electrode 100 and the second control electrode 102. Alternately, the connecting lines CL, the first control electrodes 100, and the second control electrodes 102 are not formed at the same time.

Where the area of the first control electrode 100 is equal to or slightly smaller than the area of the light-transmitting region P1, the connecting line CL is at least partially disposed in the light-transmitting region P1. In this structure, the connecting lines CL may be made of, for example, a light-transmitting conductive material to improve the light transmittance of the light-transmitting regions P1. Alternately, the connecting lines CL may be made of a non-light-transmitting conductive material. Moreover, adverse impacts on light transmittance caused by the connecting lines CL may be reduced through the design of the line width, thickness, quantity, or connection method of the connecting lines CL.

When the area of the first control electrode 100 is slightly greater than the area of the light-transmitting region P1, the connecting lines CL may not overlap the light-transmitting regions P1 in a direction Z. In this structure, the connecting lines CL may be made of a light-transmitting conductive material or a non-light-transmitting conductive material.

In other embodiments, other conductive features (e.g., conductive through holes or other circuits) may replace the connecting lines CL to electrically connect the first control electrodes 100.

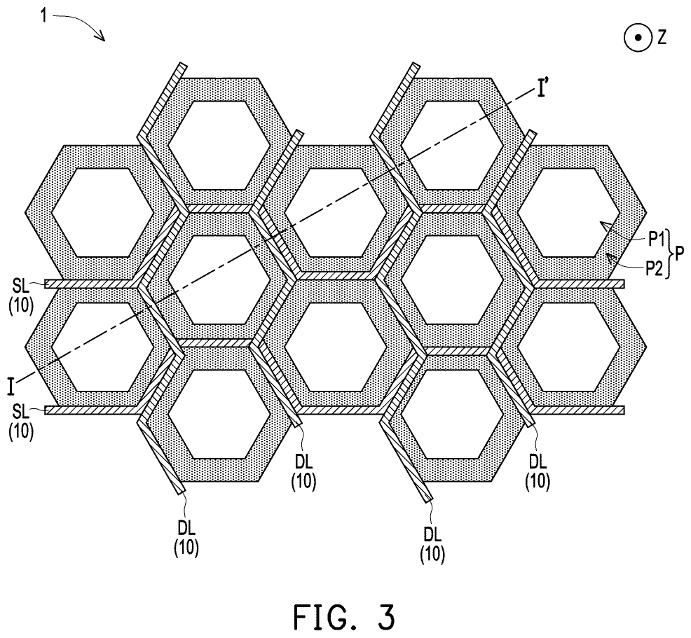

In some embodiments, as shown in FIG. 3, the element array substrate 10 further includes multiple scan lines SL and multiple data lines DL. The scan lines SL and the data lines DL intersect each other. The scan lines SL are electrically insulated from the data lines DL through at least one insulating layer (not shown). In some embodiments, as shown in FIG. 3, the scan lines SL and the data lines DL are all disposed in the non-light-transmitting regions P2 in the pixel regions P. In some embodiments, as shown in FIG. 3, each of the scan lines SL and each of the data lines DL may extend along the boundaries between the pixel regions P, but the disclosure is not limited thereto. In some embodiments, although not illustrated, the element array substrate 10 may further include multiple switching elements, multiple common electrode lines, multiple power lines, and/or multiple storage capacitors, and these elements may be disposed in the non-light-transmitting regions P2 in the pixel regions P.

Referring to FIG. 4, the partition layer 11 is formed on the element array substrate 10 through, for example, a photolithography process. In other words, the partition layer 11 may directly contact the element array substrate 10. Between the partition layer 11 and the element array substrate 10, there is no dark adhesive layer used in the prior art for attaching the electronic paper film to the element array substrate. For example, a material of the partition layer 11 may include a photo resist, such as a positive photo resist or a negative photo resist. However, the material of the partition layer 11 is not limited to photo resists. In other embodiments, the partition layer 11 may be formed with other dielectric materials or insulating materials, and the openings A of the partition layer 11 may be formed through any suitable patterning process (e.g., laser drilling, etching, other processes, or combinations thereof). The openings A are respectively surrounded by the partition walls 110 in the partition layer 11. In a cross-sectional view as shown in FIG. 4, a shape of the partition walls 110 may be trapezoidal, but is not limited thereto. In other embodiments, the shape of the partition walls 110 may be inverted trapezoidal or other shapes (depending on the method and parameters used in the patterning process).

In a cross-sectional view as shown in FIG. 4, two adjacent partition walls 110 are respectively disposed on opposite sides (e.g., the left side and the right side) of a corresponding first control electrode 100. In some embodiments, two adjacent partition walls 110 may not overlap the corresponding first control electrode 100 in the direction Z. In some embodiments, in a cross-sectional view as shown in FIG. 4, the partition walls 110 may be disposed at a boundary B between the pixel regions P, and a partition wall 110 of the partition walls 110 may be disposed on two adjacent second control electrodes 102 of the second control electrodes 102. In some embodiments, the partition wall 110 is disposed opposite to a gap G between two adjacent second control electrodes 102 underneath. The two adjacent second control electrodes 102 are able to remain electrically independent through the gap G.

Each second control electrode 102 has an outer edge EP close to the adjacent second control electrode 102 and an inner edge EI close to the first control electrode 100. In some embodiments, the outer edge EP of the second control electrode 102 overlaps the partition wall 110 in the direction Z. The inner edge EI of the second control electrode 102 may not overlap the partition wall 110 in the direction Z. For example, a side of the second control electrode 102 close to the first control electrode 100 may extend from the partition wall 110 to an edge of the non-light-transmitting region P2 so that the inner edge EI of the second control electrode 102 is not covered by the partition wall 110.

The electrophoretic layer 12 is disposed in the openings A. In some embodiments, as shown in FIG. 4, the electrophoretic layer 12 may include an electrophoretic fluid 120 and multiple white electrophoretic particles 122, but is not limited thereto. The electrophoretic fluid 120 and the white electrophoretic particles 122 may be filled in the openings A through coating, but are not limited thereto. In some embodiments, the electrophoretic fluid 120 is transparent. The white electrophoretic particles 122 are distributed in the electrophoretic fluid 120. The white electrophoretic particles 122 may be charged particles with light-reflecting properties. A distribution of the white electrophoretic particles 122 may be controlled by controlling the voltages of the first control electrodes 100 and the second control electrodes 102, thereby controlling a state (e.g., a reflective state or a transmissive state) that each pixel region P of the transmissive electrophoretic display device 1 presents, or controlling an image displayed by the transmissive electrophoretic display device 1.

A description with multiple negatively charged white electrophoretic particles 122 as examples is provided below. By applying negative voltages to the first control electrode 100 and the second control electrode 102 in the pixel region P, due to a principle of like charges repelling each other, the white electrophoretic particles 122 are repelled by the first control electrode 100 and the second control electrode 102, thus being distributed in the opening A on a side away from the first control electrode 100 and the second control electrode 102 (e.g., at a top portion of the opening A), as shown by the first and third pixel regions P from the left in FIG. 4. As the white electrophoretic particles 122 have light-reflecting properties, a light incident on the pixel region P is reflected by the white electrophoretic particles 122 distributed at the top portion of the opening A, that is, the pixel region P is in the reflective state or presented as a white screen. On the other hand, by applying a negative voltage to the first control electrode 100 and a positive voltage to the second control electrode 102 in the pixel region P, due to a principle of like charges repelling each other and opposite charges attracting each other, the white electrophoretic particles 122 are repelled by the first control electrode 100 and attracted by the second control electrode 102, thus being distributed close to the second control electrode 102 (e.g., distributed at a bottom edge of the opening A), as shown by the second and fourth pixel regions P from the left in FIG. 4. Due to a light-transmitting property of the electrophoretic fluid 120, a light incident on the pixel region P penetrates the pixel region P, that is, the pixel region P is in the transmissive state (a state allowing for penetration by light). A portion of the second control electrode 102 uncovered by the partition wall 110 effectively attracts the white electrophoretic particles 122, causing the white electrophoretic particles 122 to be concentrated at the bottom edge of the opening A, further ensuring the light transmittance of the pixel region P in the transmissive state.

In other embodiments, although not illustrated, the white electrophoretic particles 122 may be replaced with electrophoretic particles of other colors so as to provide a color display screen.

The light-transmitting conductive substrate 13 is disposed on the partition layer 11 and the electrophoretic layer 12. In some embodiments, the transmissive electrophoretic display device 1 further includes a light-transmitting adhesive layer 14. The light-transmitting conductive substrate 13 may be attached to the partition layer 11 through the light-transmitting adhesive layer 14. The light-transmitting adhesive layer 14 may include optical clear adhesive (OCA) or optical clear resin (OCR), but is not limited thereto. The light-transmitting conductive substrate 13 may include a light-transmitting substrate 130 and a light-transmitting conductive layer 132. A material of the light-transmitting substrate 130 includes glass, quartz, ceramic, sapphire, or plastic, but is not limited thereto. The light-transmitting conductive layer 132 is disposed on a surface of the light-transmitting substrate 130 facing the partition layer 11. The light-transmitting conductive layer 132 may be made of the aforementioned light-transmitting conductive material. In some embodiments, a fixed voltage may be applied to the light-transmitting conductive layer 132. However, the disclosure is not limited thereto.

In some embodiments, a manufacturing method of the transmissive electrophoretic display device 1 may include the following steps. The element array substrate 10 is provided. The element array substrate 10 includes multiple first control electrodes 100 and multiple second control electrodes 102. The first control electrodes 100 are respectively disposed in the light-transmitting regions P1 in the pixel regions P, and the second control electrodes 102 are respectively disposed in the non-light-transmitting regions P2 in the pixel regions P. The partition layer 11 is formed on the element array substrate 10 through a photolithography process. The partition layer 11 has multiple openings A respectively exposing the light-transmitting regions P1. The electrophoretic layer 12 is filled in the openings A. The partition layer 11 and the electrophoretic layer 12 are covered by the light-transmitting conductive substrate 13.

In some embodiments, as mentioned above, forming the partition layer 11 may include forming multiple partition walls 110 in the partition layer 11 at the boundary B between the pixel regions P. A partition wall 110 of the partition walls 110 is disposed on two adjacent second control electrodes 102 of the second control electrodes 102. In some embodiments, as mentioned above, the material of the partition layer 11 may include a photo resist. In a cross-sectional view, as shown in FIG. 4, the shape of the partition walls 110 may be trapezoidal or inverted trapezoidal. In some embodiments, as mentioned above, the light-transmitting conductive substrate 13 may be attached to the partition layer 11 through the light-transmitting adhesive layer 14.

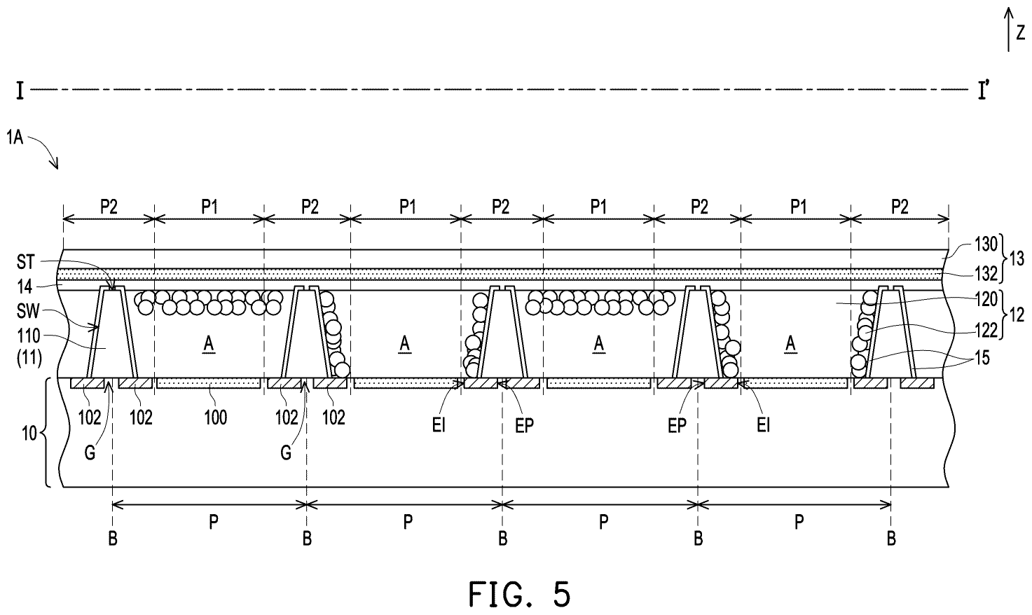

Referring to FIG. 5, a main difference between a transmissive electrophoretic display device 1A and the transmissive electrophoretic display device 1 in FIG. 4 is that the transmissive electrophoretic display device 1A further includes multiple sidewall electrodes 15. The sidewall electrodes 15 are respectively disposed on multiple side walls SW of the partition walls 110 and electrically connected to the second control electrodes 102. In some embodiments, as shown in FIG. 5, the sidewall electrode 15 may further extend from the sidewall SW of the partition wall 110 to a top surface ST of the partition wall 110. In a cross-sectional view as shown in FIG. 5, two adjacent sidewall electrodes 15 on opposite sides (e.g., the left and right sides) of the partition wall 110 are separated from each other and electrically independent. In some embodiments, an electrical connection between the sidewall electrode 15 and the corresponding second control electrode 102 may be realized through direct contact. Alternately, although not illustrated, the electrical connection between the sidewall electrode 15 and the corresponding second control electrode 102 may be realized through conductive features (e.g., conductive vias, wires, or combinations thereof) without direct contact. The sidewall electrode 15 may be made of a light-transmitting conductive material or a non-light-transmitting conductive material.

A main difference between a manufacturing method of the transmissive electrophoretic display device 1A and the manufacturing method of the transmissive electrophoretic display device 1 in FIG. 4 is that the manufacturing method of the transmissive electrophoretic display device 1A further includes forming multiple sidewall electrodes 15 on the sidewalls SW of the partition walls 110 in the partition layer 11, and the sidewall electrodes 15 are electrically connected to the second control electrodes 102 respectively.

Through the disposition of the sidewall electrodes 15, a reaction rate of the white electrophoretic particles 122 is improved. Alternatively, a reaction time of the white electrophoretic particles 122 is shortened.

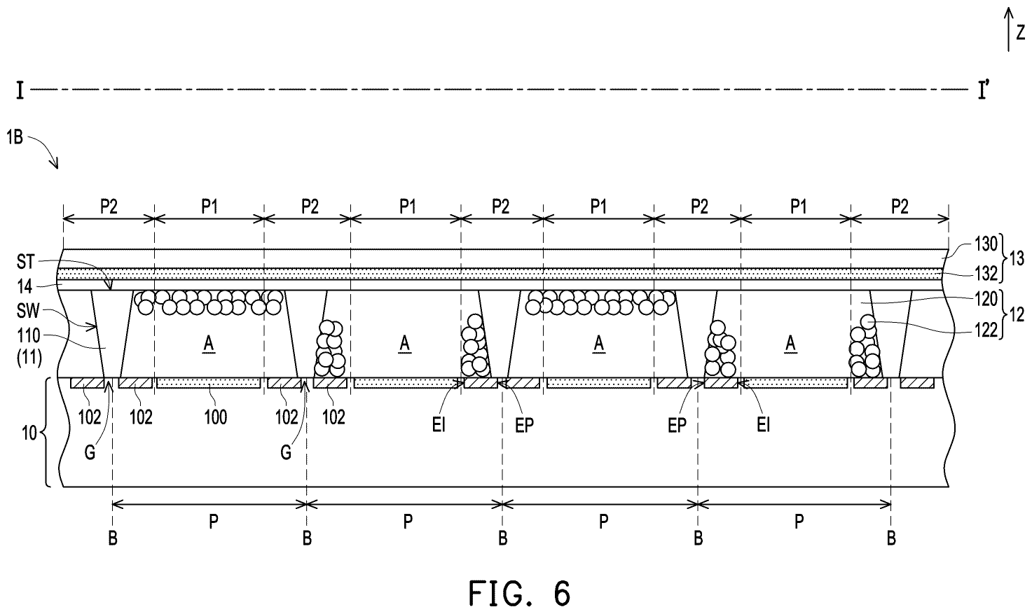

Referring to FIG. 6, a main difference between a transmissive electrophoretic display device 1B and the transmissive electrophoretic display device 1 in FIG. 4 is that in a cross-sectional view, a shape of the partition walls 110 of the transmissive electrophoretic display device 1B is inverted trapezoidal, while the shape of the partition walls 110 of the transmissive electrophoretic display device 1 in FIG. 4 is trapezoidal. Specifically, the partition walls 110 in both FIGS. 4 and 6 are formed through a photolithography process, with a main difference being the photoresist materials used. The material of the partition layer 11 in FIG. 4 is, for example, a positive photo resist, while a material of the partition layer 11 in FIG. 6 is, for example, a negative photo resist.

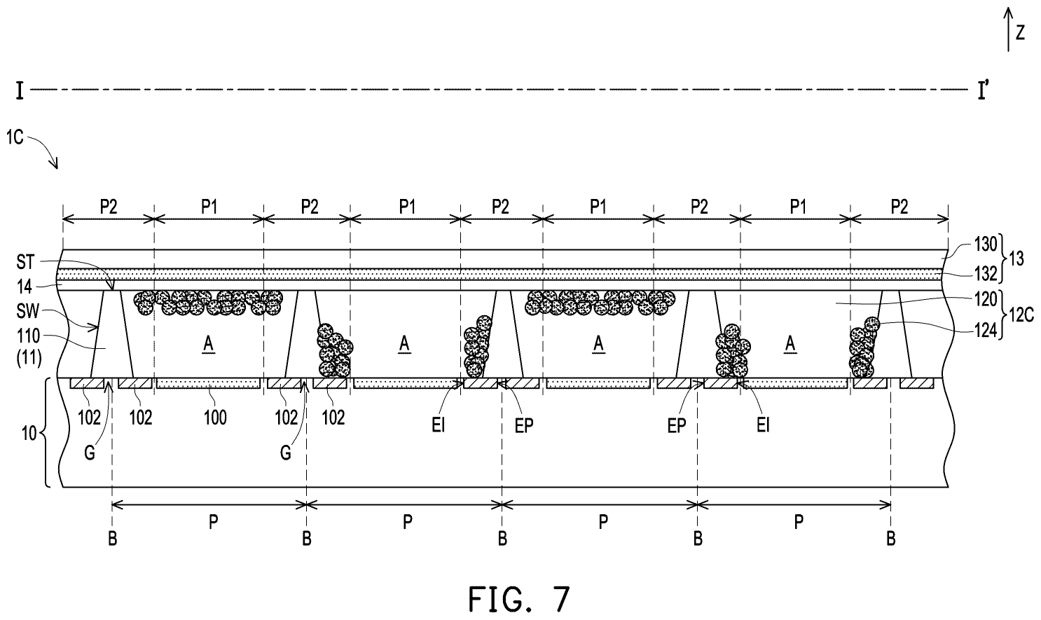

Referring to FIGS. 7 to 9, a transmissive electrophoretic display device 1C, a transmissive electrophoretic display device 1D, and a transmissive electrophoretic display device 1E are similar to the transmissive electrophoretic display device 1 in FIG. 4, the transmissive electrophoretic display device 1A in FIG. 5, and the transmissive electrophoretic display device 1B in FIG. 6 respectively, with a main difference being that electrophoretic layers 12C in the transmissive electrophoretic display device 1C, the transmissive electrophoretic display device 1D, and the transmissive electrophoretic display device 1E include electrophoretic fluids 120 and multiple black electrophoretic particles 124. The black electrophoretic particles 124 are distributed in the electrophoretic fluid 120. The black electrophoretic particles 124 may be charged particles with light-absorbing properties. A distribution of the black electrophoretic particles 124 may be controlled by controlling the voltages of the first control electrodes 100 and the second control electrodes 102, thereby controlling a state (e.g., an absorbing state or a transmissive state) that each pixel region P of the transmissive electrophoretic display device 1C, the transmissive electrophoretic display device 1D, or the transmissive electrophoretic display device 1E presents, or controlling an image displayed by the transmissive electrophoretic display device 1C, the transmissive electrophoretic display device 1D, or the transmissive electrophoretic display device 1E.

A description with multiple positively charged black electrophoretic particles 124 as examples is provided below. By applying positive voltages to the first control electrode 100 and the second control electrode 102 in the pixel region P, due to the principle of like charges repelling each other, the black electrophoretic particles 124 are repelled by the first control electrode 100 and the second control electrode 102, thus being distributed in the opening A on a side away from the first control electrode 100 and the second control electrode 102 (e.g., at the top portion of the opening A), as shown by the first and third pixel regions P from the left in FIGS. 7 to 9. As the black electrophoretic particles 124 have light-absorbing properties, a light incident on the pixel region P is absorbed by the black electrophoretic particles 124 distributed at the top portion of the opening A, that is, the pixel region P is in the absorbing state or presented as a black screen. On the other hand, by applying a positive voltage to the first control electrode 100 and a negative voltage to the second control electrode 102 in the pixel region P, due to the principle of like charges repelling each other and opposite charges attracting each other, the black electrophoretic particles 124 are repelled by the first control electrode 100 and attracted by the second control electrode 102, thus being distributed close to the second control electrode 102 (e.g., distributed at the bottom edge of the opening A), as shown by the second and fourth pixel regions P from the left in FIGS. 7 to 9. Due to the light-transmitting property of the electrophoretic fluid 120, a light incident on the pixel region P penetrates the pixel region P, that is, the pixel region P is in the transmissive state (the state allowing for penetration by light). The portion of the second control electrode 102 black electrophoretic particles 124, causing the black electrophoretic particles 124 to be concentrated at the bottom edge of the opening A, further ensuring the light transmittance of the pixel region P in the transmissive state.

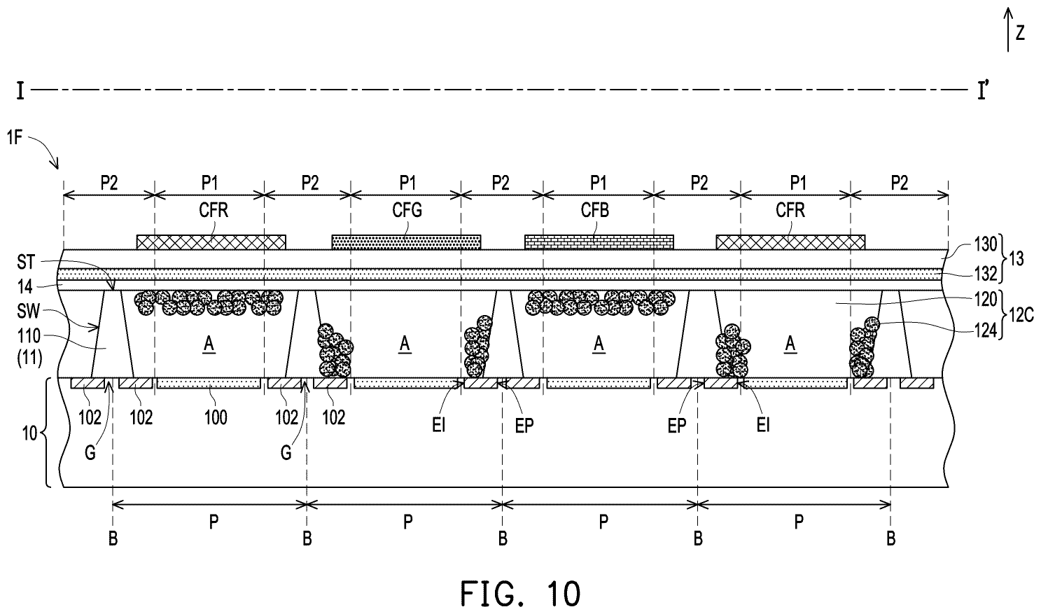

Referring to FIGS. 10 to 12, a transmissive electrophoretic display device 1F, a transmissive electrophoretic display device 1G, and a transmissive electrophoretic display device 1H are similar to the transmissive electrophoretic display device 1C, the transmissive electrophoretic display device 1D, and the transmissive electrophoretic display device 1E in FIGS. 7 to 9 respectively, with a main difference being that the transmissive electrophoretic display device 1F, the transmissive electrophoretic display device 1G, and the transmissive electrophoretic display device 1H further include multiple color filter patterns (e.g., a color filter pattern CFR, a color filter pattern CFG, and a color filter pattern CFB). The color filter patterns are disposed on the light-transmitting conductive substrate 13 and respectively overlapping the light-transmitting regions P1 in the pixel regions P. For example, the color filter pattern CFR, the color filter pattern CFG, and the color filter pattern CFB may be a red filter pattern, a green filter pattern, and a blue filter pattern respectively, but are not limited thereto. In some embodiments, orthogonal projections of the color filter patterns on the element array substrate 10 may be respectively greater than or equal to the light-transmitting regions P1, but are not limited thereto.

A main difference between a manufacturing method of the transmissive electrophoretic display device 1F, the transmissive electrophoretic display device 1G, or the transmissive electrophoretic display device 1H and a manufacturing method of the transmissive electrophoretic display device 1C, the transmissive electrophoretic display device 1D, or the transmissive electrophoretic display device 1E in FIGS. 7 to 9 is that the manufacturing method of the transmissive electrophoretic display device 1F, the transmissive electrophoretic display device 1G, or the transmissive electrophoretic display device 1H further includes forming multiple color filter patterns (e.g., the color filter pattern CFR, the color filter pattern CFG, and the color filter pattern CFB) on the light-transmitting conductive substrate 13, wherein the color filter patterns respectively overlap the light-transmitting regions P1 in the pixel regions P.

Through the disposition of the color filter patterns, full-color display is realized. In other embodiments, although not illustrated, the black electrophoretic particles 124 may be replaced with electrophoretic particles of other colors. For example, the black electrophoretic particles 124 may be replaced with the white electrophoretic particles 122. Alternatively, the black electrophoretic particles 124 may be replaced with multiple colored electrophoretic particles to provide a color display screen. In this structure, the color filter patterns may be selectively omitted.

In summary, in the embodiments of this disclosure, the electrophoretic particle in the electrophoretic layer may be controlled through multiple control electrodes. The partition layer may be formed on the element array substrate, thereby omitting the dark adhesive layer used in the prior art for attaching the electronic paper film to the element array substrate. The transmissive electrophoretic display device is light-transmitting as a result.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A transmissive electrophoretic display device, having a plurality of pixel regions, wherein each of the plurality of pixel regions has a light-transmitting region and a non-light-transmitting region, and transmissive electrophoretic display device comprises:
an element array substrate, comprising:
a plurality of first control electrodes, respectively disposed in the plurality of light-transmitting regions in the plurality of pixel regions; and
a plurality of second control electrodes, respectively disposed in the plurality of non-light-transmitting regions in the plurality of pixel regions;
a partition layer, disposed on the element array substrate and having a plurality of openings respectively exposing the plurality of light-transmitting regions, wherein in a cross-sectional view, the partition layer comprises a plurality of partition walls, and two adjacent partition walls of the plurality of partition walls are respectively disposed on opposite sides of a corresponding first control electrode of the plurality of first control electrodes;
an electrophoretic layer, disposed in the plurality of openings; and
a light-transmitting conductive substrate, covering the partition layer and the electrophoretic layer.

2. The transmissive electrophoretic display device of claim 1, wherein in a top view, the plurality of second control electrodes respectively surround the plurality of first control electrodes.

3. The transmissive electrophoretic display device of claim 1, wherein the plurality of first control electrodes are electrically connected to each other, and the plurality of second control electrodes are electrically independent of each other.

4. The transmissive electrophoretic display device of claim 1, wherein in the cross-sectional view, the plurality of partition walls are disposed at a boundary between the plurality of pixel regions, and a partition wall of the plurality of partition walls is disposed on two adjacent second control electrodes of the plurality of second control electrodes.

5. The transmissive electrophoretic display device of claim 1, wherein a material of the partition layer comprises a photo resist, and in the cross-sectional view, a shape of the plurality of partition walls is trapezoidal or inverted trapezoidal.

6. The transmissive electrophoretic display device of claim 1, further comprising:
a light-transmitting adhesive layer, wherein the light-transmitting conductive substrate is attached to the partition layer through the light-transmitting adhesive layer.

7. The transmissive electrophoretic display device of claim 1, further comprising:
a plurality of sidewall electrodes, respectively disposed on a plurality of side walls of the plurality of partition walls and electrically connected to the plurality of second control electrodes.

8. The transmissive electrophoretic display device of claim 1, further comprising:
a plurality of color filter patterns, disposed on the light-transmitting conductive substrate and respectively overlapping the plurality of light-transmitting regions in the plurality of pixel regions.

9. The transmissive electrophoretic display device of claim 1, wherein an aperture ratio of the plurality of pixel regions falls between 60% and 80%.

10. A manufacturing method of a transmissive electrophoretic display device, the transmissive electrophoretic display device having a plurality of pixel regions, wherein each of the plurality of pixel regions has a light-transmitting region and a non-light-transmitting region, and the manufacturing method of the transmissive electrophoretic display device comprises:
providing an element array substrate, the element array substrate comprising a plurality of first control electrodes and a plurality of second control electrodes, wherein the plurality of first control electrodes are respectively disposed in the plurality of light-transmitting regions in the plurality of pixel regions, and the plurality of second control electrodes are respectively disposed in the plurality of non-light-transmitting regions in the plurality of pixel regions;
forming a partition layer on the element array substrate through a photolithography process, wherein the partition layer has a plurality of openings respectively exposing the plurality of light-transmitting regions;
filling an electrophoretic layer in the plurality of openings; and
covering the partition layer and the electrophoretic layer with a light-transmitting conductive substrate.

11. The manufacturing method of the transmissive electrophoretic display device of claim 10, wherein forming the partition layer comprises forming a plurality of partition walls in the partition layer at a boundary between the plurality of pixel regions, wherein a partition wall of the plurality of partition walls is disposed on two adjacent second control electrodes of the plurality of second control electrodes.

12. The manufacturing method of the transmissive electrophoretic display device of claim 10, wherein a material of the partition layer comprises a photo resist, and in a cross-sectional view, a shape of a plurality of partition walls is trapezoidal or inverted trapezoidal.

13. The manufacturing method of the transmissive electrophoretic display device of claim 10, wherein the light-transmitting conductive substrate is attached to the partition layer through a light-transmitting adhesive layer.

14. The manufacturing method of the transmissive electrophoretic display device of claim 10, further comprising:
forming a plurality of sidewall electrodes on a plurality of side walls of the plurality of partition walls in the partition layer, wherein the plurality of sidewall electrodes are electrically connected to the plurality of second control electrodes respectively.

15. The manufacturing method of the transmissive electrophoretic display device of claim 10, further comprising:
forming a plurality of color filter patterns on the light-transmitting conductive substrate, wherein the plurality of color filter patterns respectively overlap the plurality of light-transmitting regions in the plurality of pixel regions.
